(19) United States
(12) Patent Application Publication
(10) Pub. No.: US 2011/0249449 A1
(43) Pub. Date: Oct. 13, 2011

(54) OPTICAL SEMICONDUCTOR DEVICE MODULE

(75) Inventor: Yoshihisa Tashiro, Tokyo (JP)

(73) Assignee: MITSUBISHI ELECTRIC CORPORATION, Tokyo (JP)

(21) Appl. No.: 12/958,438

(22) Filed: Dec. 2, 2010

(30) Foreign Application Priority Data
Apr. 9, 2010 (JP) 2010-090089

(51) Int. Cl. F21V 3/04

(52) U.S. Cl. 362/311.04

(57) ABSTRACT

An optical semiconductor device module comprises: a stem; an optical semiconductor device mounted on the stem; a cap fixed on the stem and covering the optical semiconductor device; a plastic lens fixed to the cap and collecting outgoing light from the optical semiconductor device; and a glass plate fixed to the cap and sealing the optical semiconductor device.

### BACKGROUND OF THE INVENTION

1. Field of the Invention

The present invention relates to an optical semiconductor device module for optical communications, and in particular to an optical semiconductor device module capable of sufficiently sealing an optical semiconductor device and reducing the manufacturing costs.

2. Background Art

In an optical semiconductor device module for optical communications, a lens for collecting outgoing light of the optical semiconductor device is fixed to a cap. Conventionally, a glass lens has been used as a lens. By the glass lens, both the seal of the optical semiconductor device and light collecting have been realized (for example, refer to Japanese Patent Application Laid-Open No. 2005-352075).

### SUMMARY OF THE INVENTION

However, since the glass lens is expensive, the manufacturing costs of conventional optical semiconductor device module are high. On the other hand, although plastic lenses are available as inexpensive lenses, the plastic lenses cannot sufficiently seal the optical semiconductor device due to the relationship with other materials. Therefore, inexpensive plastic lenses have not been used for optical semiconductor device modules for optical communications that require sealing.

In view of the above-described problems, an object of the present invention is to provide an optical semiconductor device module capable of sufficiently sealing an optical semiconductor device and reducing the manufacturing costs.

According to the present invention, an optical semiconductor device module comprises: a stem; an optical semiconductor device mounted on the stem; a cap fixed on the stem so as to cover the optical semiconductor device; a plastic lens fixed to the cap and collecting an outgoing light from the optical semiconductor device; and a glass plate fixed to the cap and sealing the optical semiconductor device.

The present invention makes it possible to sufficiently seal an optical semiconductor device and reduce the manufacturing costs.

Other and further objects, features and advantages of the invention will appear more fully from the following description.

### BRIEF DESCRIPTION OF THE DRAWINGS

FIG. 1 is a sectional view showing an optical semiconductor device module according to the first embodiment.

FIG. 2 is a sectional view showing a modification example of an optical semiconductor device module according to the first embodiment.

FIG. 3 is a sectional view showing an optical semiconductor device module according to the second embodiment.

FIG. 4 is a sectional view showing a first modification example of an optical semiconductor device module according to the second embodiment.

FIG. 5 is a sectional view showing a second modification example of an optical semiconductor device module according to the second embodiment.

FIG. 6 is a sectional view showing an optical semiconductor device module according to the third embodiment.

FIG. 7 is a sectional view showing a modification example of the optical semiconductor device module according to the third embodiment.

FIG. 8 is a sectional view showing an optical semiconductor device module according to the fourth embodiment.

### DETAILED DESCRIPTION OF THE PREFERRED EMBODIMENTS

Now, embodiments of the present invention will be described with reference to the drawings. Same reference numerals denote same components throughout the drawings, and redundant descriptions will be omitted.

### First Embodiment

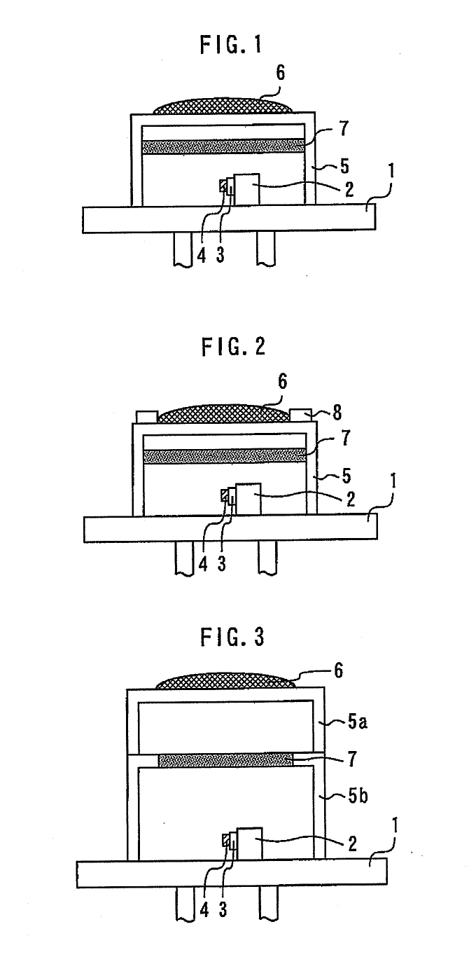

FIG. 1 is a sectional view showing an optical semiconductor device module according to the first embodiment. A semiconductor laser 4 (optical semiconductor device) is mounted on the stem 1 via a heat sink 2 and the sub-mount 3. A cap 5 is fixed on the stem 1 so as to cover the semiconductor laser 4. A plastic lens 6 and a glass plate 7 are fixed to the cap 5. The plastic lens 6 collects the outgoing light from the semiconductor laser 4. The glass plate 7 seals the semiconductor laser 4.

By thus using the glass plate 7, the semiconductor laser 4 can be sufficiently sealed. By using the plastic lens 6, the manufacturing costs can be reduced.

FIG. 2 is a sectional view showing a modification example of an optical semiconductor device module according to the first embodiment. The cap 5 has a mark 8 (guide) on the location where the plastic lens 6 is installed. By the mark 8, the plastic lens 6 can be accurately fixed to the location in the cap 5.

### Second Embodiment

FIG. 3 is a sectional view showing an optical semiconductor device module according to the second embodiment. A cap 5a (first cap) wherein the plastic lens 6 is installed and a cap 5b (second cap) wherein the glass plate 7 is installed are different members. The cap 5a is overlapped on the cap 5b. Thereby, caps 5a and 5b can be fabricated by using conventional techniques.

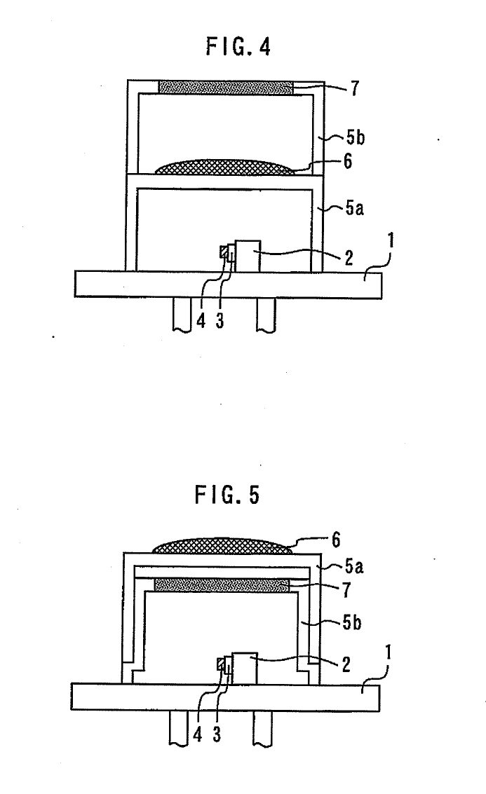

FIG. 4 is a sectional view showing a first modification example of an optical semiconductor device module according to the second embodiment. In this modification example, the cap 5s is overlapped on the cap 5b, and the plastic lens 6 is nearer to the semiconductor laser 4 than the glass plate 7. Thereby, since the plastic lens 6 becomes close to the light-emitting region, light collecting becomes easier.

FIG. 5 is a sectional view showing a second modification example of an optical semiconductor device module according to the second embodiment. In this modification example, the upper cap 5a is fitted in the lower cap 5b. Thereby, since the location of the upper cap 5a is automatically determined when the location of the lower cap 5b is determined, no alignment is required.

### Third Embodiment

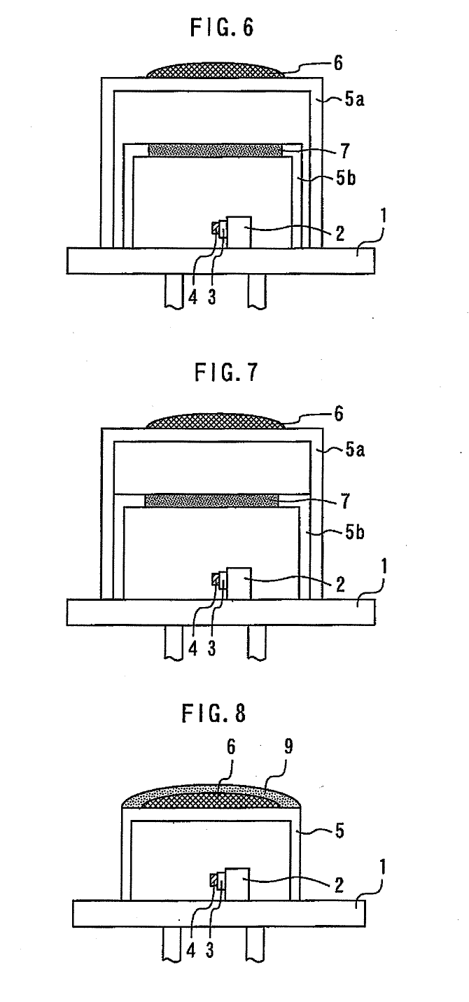

FIG. 6 is a sectional view showing an optical semiconductor device module according to the third embodiment. A cap 5a wherein the plastic lens 6 is installed and a cap 5b wherein the glass plate 7 is installed are different members. The cap 5a and the cap 5b are fixed to the stem 1, respectively. The cap 5a covers the cap 5b. Thereby, the caps 5a and 5b can be fabricated by using conventional techniques, and the caps 5a and 5b can be fixed to the stem 1 by using conventional techniques.

FIG. 7 is a sectional view showing a modification example of the optical semiconductor device module according to the third embodiment. In this modification example, the internal wall of the external cap 5a contacts the external wall of the internal cap 5b. Thereby, since the location of the external cap 5a is automatically determined when the location of the internal cap 5b is determined, no alignment is required.

### Fourth Embodiment

FIG. 8 is a sectional view showing an optical semiconductor device module according to the fourth embodiment. In the present embodiment, a coating film 9 such as silicon nitride or silicon oxide is placed in place of the glass plate 7 described in the first to third embodiments. The coating film 9 coats the cap 5 over the plastic lens 6 and seals the semiconductor laser 4. Thereby, effects equivalent to the effects of the first embodiment can be obtained. The coating film 9 may be placed inside the cap 5.

Obviously many modifications and variations of the present invention are possible in the light of the above teachings. It is therefore to be understood that within the scope of the appended claims the invention may be practiced otherwise than as specifically described.

The entire disclosure of a Japanese Patent Application No. 2010-090089, filed on Apr. 9, 2010 including specification, claims, drawings and summary, on which the Convention priority of the present application is based, are incorporated herein by reference in its entirety.

1. An optical semiconductor device module comprising:
a stem;
an optical semiconductor device mounted on the stem;
a cap fixed on the stem and covering the optical semiconductor device;
a plastic lens fixed to the cap and collecting outgoing light from the optical semiconductor device; and
a glass plate fixed to the cap and sealing the optical semiconductor device.

2. The optical semiconductor device module according to claim 1, wherein the cap has a mark on a location where the plastic lens is installed.

3. The optical semiconductor device module according to claim 1, wherein
the cap includes a first cap on which the plastic lens is installed and a second cap on which the glass plate is installed, and
one of the first cap and the second cap overlaps the other.

4. The optical semiconductor device module according to claim 3, wherein the second cap overlaps the first cap, and the plastic lens is nearer to the optical semiconductor device than is the glass plate.

5. The optical semiconductor device module according to claim 3, wherein the upper one of the first cap and the second cap is fitted in the lower one of the first cap and the second cap.

6. The optical semiconductor device module according to claim 1, wherein
the cap includes a first cap on which the plastic lens is installed, and a second cap on which the glass plate is installed,
the first cap and the second cap are fixed on the stem, and
one of the first cap and the second cap covers the other.

7. The optical semiconductor device module according to claim 6, wherein an internal wall of the external one of the first cap and the second cap contacts an external wall of the internal one of the first cap and the second cap.

8. The optical semiconductor device module comprising:
an optical semiconductor device;
a stem on which the optical semiconductor device is mounted;
a cap fixed on the stem and covering the optical semiconductor device;
a plastic lens fixed to the cap and collecting outgoing light from the optical semiconductor device; and
a coating film coating the cap and sealing the optical semiconductor device.
